(19) United States
(12) Patent Application Publication
(10) Pub. No.: US 2008/0000140 A1
(43) Pub. Date: Jan. 3, 2008

(54) Fishing lure assembly

(76) Inventors: Greg J. Mitchell, Norwich, CT (US); Martin G. Algar, Old Lyme, CT (US)

Correspondence Address: MCCARTER & ENGLISH LLP;CITYPLACE I, 185 ASYLUM STREET, HARTFORD, CT, 06103, US

(21) Appl. No.: 11/820,694

(22) Filed: Jun. 20, 2007

Related U.S. Application Data
(60) Provisional application No. 60/815,120, filed on Jun. 20, 2006.
(60) Provisional application No. 60/931,684, filed on May 24, 2007.

(51) Int. Cl. A01K 85/01

(52) U.S. Cl. 43/42.06

(57) ABSTRACT

A fishing lure assembly and the method of making a unique fill composition that causes scent to be dispensed from the fishing lure assembly.

### CROSS-REFERENCE TO RELATED APPLICATIONS

Under 35 U.S.C. §119(e) this application claims the benefit of U.S. Provisional Application No. 60/815,120 filed Jun. 20, 2006; and U.S. Provisional Application No. 60/931,684 filed May 24, 2007, which are hereby incorporated by reference in its entirety. In addition, the present invention claims the benefit under 35 U.S.C. §120 of U.S. patent application Ser. No. 11/796,329 filed Apr. 27, 2007; which is a continuation application of U.S. patent application Ser. No. 11/027,377; entitled “Fishing Lure Device and Associated Method of Manufacture”, filed Dec. 31, 2004, now U.S. Pat. No. 7,228,656; which are incorporated herein by reference in their entirety for all purposes.

### FIELD OF THE INVENTION

The invention relates generally to compositions useful for recreational and commercial fishing in either freshwater or saltwater environments.

### BACKGROUND

Most fish species are known to have the ability to detect chemicals in the environment. Research has determined that certain compounds, such as amino acids contained in the excretions or blood of prey fish, physiologically stimulate the olfactory (smell) and/or gustatory (taste) receptors of predator fish. Recognized changes in certain predator fish include increased instances of snapping, biting, and swallowing, as well as increased retention time of held bait. Some fish have been observed to swim more aggressively and across wider areas when stimulant compounds are detected in the water.

In general the feeding behavior of fish takes place in two phases. The first phase includes the search for food during which time the fish responds to various stimuli to locate food. The readiness for food searching behavior is usually initiated by endogenous rhythms of activity. During this state of increased readiness to respond to feeding stimuli, external visual, vibrational and chemical stimuli can release feeding behavior. Visual, auditory, vibrational, and chemical stimuli alert the fish, whereas the visual stimuli guide the fish to chase and strike at its prey.

The second phase of fish feeding behavior encompasses the striking of the food, and includes the process of taking the food into the mouth, tasting, biting and/or masticating, and swallowing the prey. It is believed that during this phase of the feeding behavior, visual stimuli guide the intake of either the prey animal or lure offered by the fisherman. Once the food is in the fish's mouth, further manipulation of the food, i.e. biting and mastication, depends on the taste, and tactile properties of the prey item. Many fish species chew and masticate soft prey items if the prey items do not have repelling properties. Any repelling property would cause the fish to reject or expel an item taken into the mouth.

In a typical feeding situation, the fish first sees and/or hears a possible prey item; then approaches the item. If the item is recognized as possible prey, the fish rapidly approaches to within striking distance and strikes at the item by biting or rapidly sucking water containing the prey item into its mouth. Once the prey item is in the mouth, the fish uses its oral senses of touch and taste to determine whether to chew, swallow or to expel the item. It is during this identification period that the angler has the opportunity to hook the fish.

Over the past several decades the popularity of recreational sportfishing has grown dramatically. Between 1980 and 1995, the number of Americans who fished increased by 16 percent and the amount they spent on fishing equipment increased at an even greater rate. Television and the internet have brought sports related activities directly to participants and enthusiasts alike. Currently, fishing ranks as the 4^{th} most popular participation sport in the nation. It ranks ahead of bicycling, bowling, basketball, golf, jogging, baseball, softball, soccer, volleyball, tennis, football and skiing.

Saltwater fishing is more popular than ever and has seen a 77 percent growth during the past decade. Currently saltwater fishing enthusiasts are spending $1.5 billion on tackle. The popularity of the saltwater fishing market will continue as Americans continue to discover recreational outlets along our nation's coastlines, including Alaska. In 2001, over 9.1 million anglers enjoyed saltwater fishing.

Twenty-nine million Americans fished in fresh water in 2001 reflecting a 45 percent growth during the past decade. Total economic output in 2001 was $74 billion and equipment sales were greater than $10.6 billion. Freshwater fishing will also see continued growth due in part to the diversity of fishing available in America's lakes, rivers, and streams. In addition, nationally televised professional bass fishing tournaments have contributed to the growth and exposure of the sport.

Despite the growth in sportfishing popularity, current technology in fishing lures has not undergone a major change in 75 years. In an attempt to meet the demand for an effective alternative to live bait, the sportfishing industry has continued to embrace low technology products, eschewing science and innovation. As described below, the century-old concept of absorbent lures, which use oils, and the more modern paste or cream-based attractants have proven ineffective due to sub-optimal (i.e., too fast or too slow) release rates, are messy and good for one-time-only use. Urethane plastic soft lures made from water soluble or insoluble polymers also tended to release their attractants too slowly or not at all. With the enormous profits garnered by many corporations within the industry, there has been little incentive to change. Several manufacturers have taken advantage of anglers by promoting products that provide little if any advantage.

The activity of fishing with a baited line predates recorded history. In this vast period of time, inventive fishermen have tried countless baits and lures. It is for this reason that the prior art record of patents is replete with thousands of different fishing lure designs.

Many artificial lure designs are intended to make the lures visually attractive to fish. However, many species of fish do not hunt by sight alone. Many fish track prey either partially or totally based on scent. The presence of scent in the water does more than just lead predator fish to prey fish. It has been determined that certain compounds, such as amino acids, citrates, amides, proteins and the like that are contained within the scent or blood of a prey fish, cause physiological changes in a predator fish when detected by that predator fish. For example, certain predator fish have increased instances of snapping, biting and swallowing when they detect scent compounds in the water. Some fish swim more aggressively and across wider areas when scent compounds are detected in the water. Such compositions are described in the following U.S. Pat. Nos. 5,664,362; 5,185,164; 5,720,996; and 5,171,587 which are hereby incorporated by reference in their entirety. These patents describe various combinations of chemical agents, for example, amino acids, that demonstrate the ability to stimulate the feeding behavior and biting reflex of various species of fish. However, there still exists a need in the field for lures and baits which can emit or release these and other types of feeding stimulants in a controlled manner to improve the fisherman's chances of catching a fish.

It is for these reasons that many fishermen prefer to use real bait rather than artificial lures. It is also for these reasons that fishermen chum the waters where they are fishing to attract predator fish. Although the use of real bait is beneficial in fishing, it does have many drawbacks. Real bait is organic and must be kept from spoiling. It must, therefore, be kept fresh or constantly replaced. This requires refrigeration and storage. Furthermore, real bait smells and fouls all surfaces it touches. This requires that fishing boats and fishing gear be cleaned repeatedly in order to keep the boat and gear sanitary.

Recognizing the disadvantages of real bait, many inorganic lures have been developed that are scented. The scented lure will therefore attract fish like real bait without having to use real bait. In the simplest form, such prior art lures use an absorbent material that is soaked with fish oils. A problem associated with absorbent fishing lures is that they have a tendency to release their scent quickly. Thus, after the lure has been in use in the water for a short while, all the oils have left the lure and the lure is saturated with only seawater. To reuse the lure, the seawater must be rung out of the lure and the lure again saturated with fish oil. In attempts to prolong the period of time that a lure releases scent, scent compounds have been mixed with various polymers that release the scent compounds slowly in water. Although polymer based release systems do release scent slowly, the scent must be mixed with the polymer prior to the curing of the polymer. Thus, once the scent is exhausted, the lure cannot be refilled with scent and must be discarded. A summary of problems associated with currently available fishing lures and baits is provided in Table 1.

Another shortcoming of many lures on the market today is the combination of the lure's tactile and taste qualities coupled with the non-exposed barbed portion of the hook. For example, in many cases a fish strikes the lure while the barbed portion of the hook is shielded by the plastic body of the lure. A fish that takes the lure into its mouth; touches and tastes the lure; and, if the sensory properties of the lure are incorrect, quickly expels it. The angler, more often than not, is not even aware that a fish has made a strike at the lure. It would, therefore, be of benefit to a fisherman to have a lure that would be detected as a food item and not be expelled from the mouth. Of greater benefit, however, would be a lure which would actually release a biting reflex when within the fish's mouth. The reflexive biting would serve to force the barbed portion of the hook out through the fish's mouth and alert the fisherman that a fish has the lure within its mouth.

Much work has been done in associating various amino acids with both gustatory and olfactory receptors in fish. See for example: “High Sensitivity of Catfish Taste Receptors to Amino Acids”, by John Caprio, Comparative Biochemical Physiology, 1975, Vol. 52A, pp 247-251; “High Sensitivity and Specificity of Olfactory and Gustatory Receptors of Catfish to Amino Acids”, by John Caprio, Chemoreception in Fishes, Elsevier Scientific Publishing Co., Amsterdam, 1982, Chapter 7, pp 109-1241; “An Electrophysiological Investigation of the Oro-Pharyngeal (IX-X) Taste System in the Channel Catfish, Ictalurus punctatus”, by J. S. Kanwal and J. Caprio, Journal of Comparative Physiology, vol. 150, 1983, pp 345-357; and “Receptor Sites For Amino Acids in the Facial Taste System of the Channel Catfish”, by S. Wegert and J. Caprio, Journal of Comparative Physiology A. vol. 168, 1991, pp 201-211. While much work has been reported in the above articles, as well as others not listed above, with regard to the sensitivity of various gustatory and olfactory receptors to the amino acids, all of this work was from electrophysiological studies—not behavioral studies. That is, while experiments can be conducted to show that various receptors of a fish are sensitive to a particular agent, they cannot predict the behavior which will be associated with that particular agent. For example, it has been observed that a particular amino acid may either attract or repel fish, or even cause no behavior response, depending upon other past or present stimulations to the fish.

Even in those cases where fish have been attracted by the presence of certain compounds, the attraction has not been consistently followed by an increase in the feeding activity of the fish. Also, while a gustatory receptor may be equally sensitive to one stimulus which is sweet in taste, and another which is bitter or salty in taste, the behavior of the animal can be the opposite for each stimulus. Consequently, the fact that a particular agent can trigger an electrophysiological response in a receptor of a fish, it does not predict the corresponding behavior the fish will have to that agent.

There are various sprays and soaking solutions currently available that are supposed to increase the time period during which the fish retains the lure within its mouth. These sprays and solutions purportedly mask the taste of the plastic lure and, thereby, allow the angler an additional time to determine when a strike is in progress and to set the hook. However, none of the currently available sprays and/or solutions actually compels the fish to snap or bite the lure.

While various attempts have been made to incorporate various chemical compounds into fishing baits or lures to increase the likelihood that a particular fish species will bite or snap at the hooks in the bait or lure, there still exists a substantial need in the art for improved fishing lures and baits which incorporate such biting and snapping enhancers, i.e., a fishing lure which, upon entering the fish's mouth, will release both involuntary and voluntary biting movements.

In view of the above discussion, one can appreciate that the most effective fishing lure should appeal to all of the senses that a fish uses in its quest for food, including visual, vibrational, acoustic, tactile, olfactory and taste. To overcome the possibility of rejecting the lure, incorporation of an agent within a lure which releases the involuntary biting reflex would be of value to sport fisherman. Furthermore, a need exists in the field of artificial fishing lures, for a lure that slowly releases scent compounds in water, yet can be repeatedly reloaded with the scent compounds once the initial scent compounds are exhausted.

### SUMMARY OF THE INVENTION

The present invention relates to fishing lures and baits that provide for a controlled release of scent and/or chemical attractants in water. The fishing lures and baits as described herein provide for the controlled release of feeding stimulants that encourage fish to bite; can be reused; are easily “recharged” for long-term use; versatile; and durable.

TABLE 1
Shortcomings of Current Fishing Lures and Baits.

| Alternative | Downside |
|---|---|
| Natural/live bait | Rapid spoilage |
| | Expensive |
| | Unpleasant handling |
| | Very messy |
| | Durability issues resulting in |
| | one-time use |
| | Equipment requires frequent |
| | cleaning |
| Absorbent lures | Quick scent release |
| using cloth or | Incomplete attractant chemical |
| sponges soaked with | One-time use |
| fish oils | |
| Lures using creams | Messy |
| or flavored pastes | Sub-optimal release. Usually |
| applied to surface of | too slow |
| lures | Aversive chemicals can repel |
| | fish |
| | Prevents visual appeal due to |
| | being covered with paste |
| Urethane soft lures | Attractant is not |
| with water soluble | physiologically based. |
| polymers | Slow release or release |
| | insufficient to be detected |
| | Decomposition of the |
| | compound |
| Urethane soft lures | Attractant is not |
| with water insoluble | physiologically based. |
| polymers (gums) | Attractant trapped within |
| | polymer and release |
| | insufficient to be detected |
| | Decomposition of the |
| | compound within the lure |
| Scented gummi- | Tends to swell in the water and |
| worms | decompose |
| | Disintegrates in the sun |
| | One time use |
| | Some are messy and foul |
| | smelling |
| Unscented Urethane | One time use |
| worms | No neurological feeding |
| | stimulant involved |
| | Tend to tear apart easily |
| | Non-science based color |
| | patterns or design |
| Lures claiming new, | Not based on scientific |
| scientifically-based | research |
| technology and | Testing shows no improved |
| hyped in newspapers | catch ratio |
| and infomercials | Some have actually been |
| | observed to frighten fish |
| Standard rigid | Seventy year old technology |
| plastic fishing lures | and design |
| | Visual attraction only |
| | Does not release any feeding |
| | stimulant or attractant |
| | whatsoever |

In one aspect, the present invention relates to a fishing lure assembly comprising a lure body that can retain and store a volume of fill composition. The body comprises an anterior portion and a posterior portion, an internal fill or storage chamber for a receiving and storing a volume of a fill composition, a first passageway the body that is in fluid communication with the internal fill chamber and defines a flow path therebetween, and a second passageway through the body that is in fluid communication with the internal fill chamber, and wherein the second passageway includes a biasing member disposed therein. The biasing member having a predetermined modulus of elasticity, and including a hermetic seal over the opening of the second passageway, and wherein the biasing member communicates with the internal fill chamber, and optionally a hook.

### BRIEF DESCRIPTION OF THE DRAWINGS

For a better understanding of the present invention, reference is made to the following description of exemplary embodiments thereof, considered in conjunction with the accompanying drawings, in which:

FIG. 1 Illustrates a side view of an example of a spring body or diaphragm 110 for use in a fishing lure assembly.

FIG. 2 Illustrates a side perspective view of an example of a spring body or diaphragm 110 for use in a fishing lure assembly.

FIG. 3 Illustrates a bottom perspective view of an example of a spring body or diaphragm 110 for use in a fishing lure assembly.

FIG. 4 Illustrates a top perspective view of an example of a spring body or diaphragm 110 for use in a fishing lure assembly.

FIG. 5 Illustrates a side perspective view of an example of a one-way valve 80 (e.g., a duckbilled valve) for use in a fishing lure assembly.

FIG. 6 Illustrates a front perspective view of an example of an actuator body 140 for use in a fishing lure assembly.

FIG. 7 Illustrates a side perspective view of an example of an actuator body 140 for use in a fishing lure assembly.

FIG. 8 Illustrates a rear perspective view of an example of an actuator body 140 for use in a fishing lure assembly.

FIG. 9 Illustrates a perspective view of an example of a micro screen or sieve 90 for use in a fishing lure assembly.

FIG. 10 Illustrates a perspective view of an example of a micro sieve 90 for use in a fishing lure assembly.

FIG. 11 Illustrates a cross-sectional view of an exemplary embodiment of the lure body of a fishing lure assembly as described herein.

FIG. 12 Illustrates a side perspective view of an exemplary embodiment of a fishing lure assembly. The figure includes the micro screens or sieves 90 at the point where the fill port 70 and exit port passageway 60 meet the internal fill chamber 40.

FIG. 13 Illustrates a bottom or ventral perspective view of the lure body of an exemplary embodiment of a fishing lure assembly.

FIG. 14 Is a schematic diagram demonstrating how one exemplary fishing lure embodiment of the invention functions to result in the release of feeding stimulant. Briefly, the feeding stimulants are delivered through the one-way valve 80 into the internal fill chamber 40. In certain embodiments the fill chamber 40 further comprises a volume of Ion exchange material, which has been functionalized to bind the particular stimulants. The ion exchange material ionically binds the stimulants and holds them in the internal storage chamber 40. Once the lure is submerged and moved through the water, the diaphragm 110 pulses due to the force of water on the actuator 140 in the actuator chamber, and pushes against the volume of fluid in the fill chamber 40. The increase in hydrostatic pressure in the internal fill chamber 40 results in the release of feeding stimulant through the molecular sieve 90 and out of the exit port 60. The diaphragm 110 then recoils, lowering the pressure in the internal fill chamber 40, and drawing water therein via port 60, refilling it. This cycle is repeated as the lure moves through the water creating a scent “trail” of feeding stimulant.

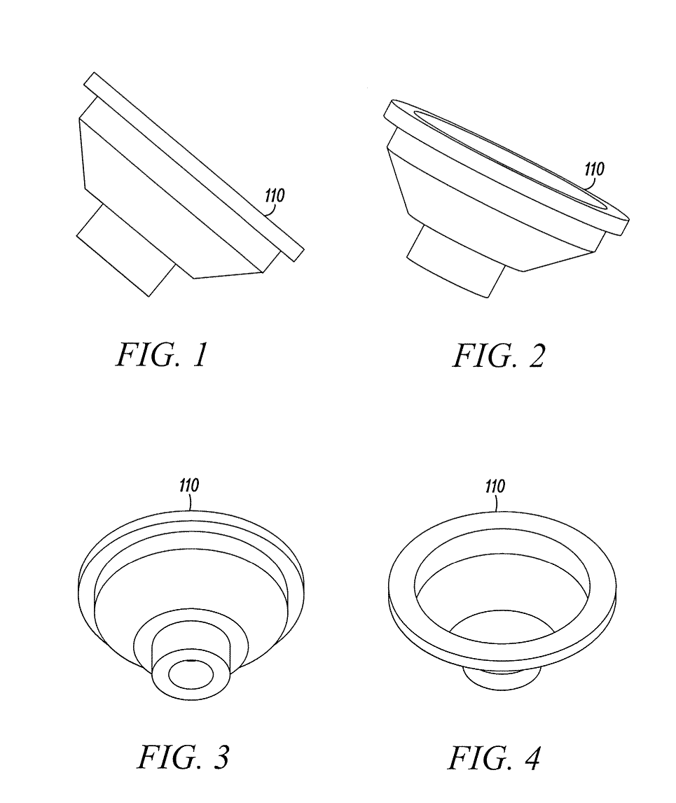

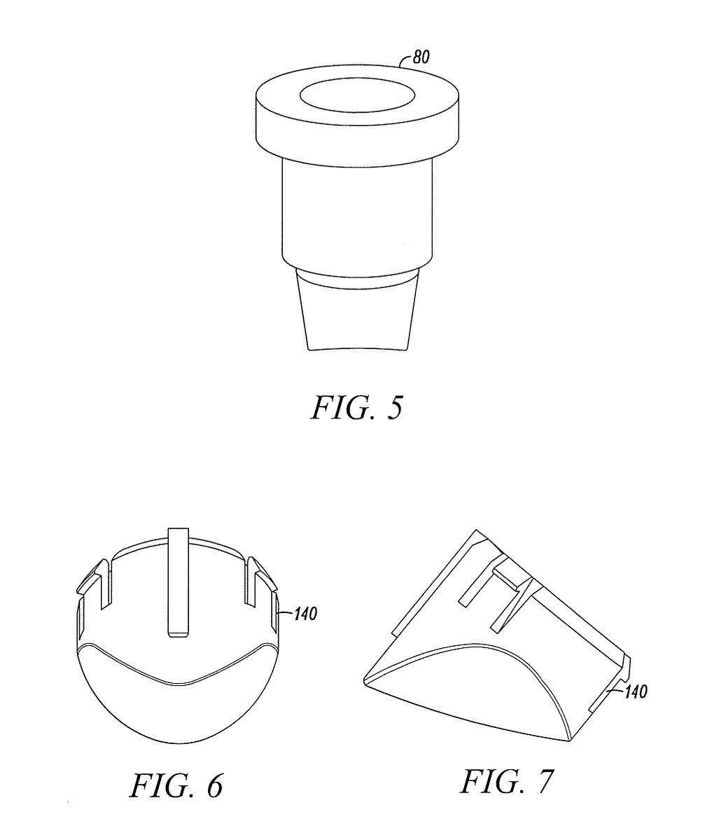

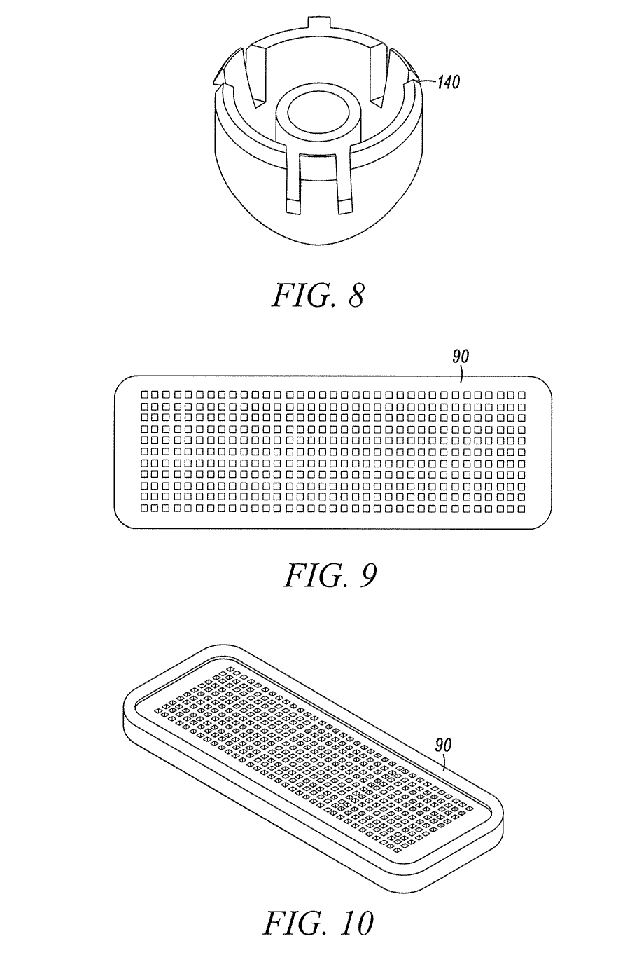

### DETAILED DESCRIPTION OF THE INVENTION

As used herein, the term “stimulants” includes “scents,” “attractants,” “feeding stimulants,” and the like and are used interchangeably to refer to various compounds found naturally in fish, fish prey or produced synthetically that attract and/or have a positive physiological effect on the feeding behavior of predatory fish. Such scent compounds include, but are not limited to, organic compounds including, amino acids (e.g., d-, l-, alpha, beta, and gamma amino acids), peptides, proteins, lipids, oils, amides, citrates and anise.

As will be understood by those of ordinary skill in the art, the invention is not limited to the fishing lure assembly shown and described in the drawings and described in the specification. For example, the lure can be of any suitable size, shape, or color. The lure may also be constructed of any suitable material such as wood, metal, plastic, rubber, elastomeric polymers, and the like which are well known by those of skill in the art. In addition, the lure can comprise additional features not illustrated in the figures, such as a multitude of feeding attractant fill compositions. In addition, the lure assembly of the invention may be segmented, for example comprise a hinged segment such that the lure demonstrates a more “life-like” motion when pulled though the water.

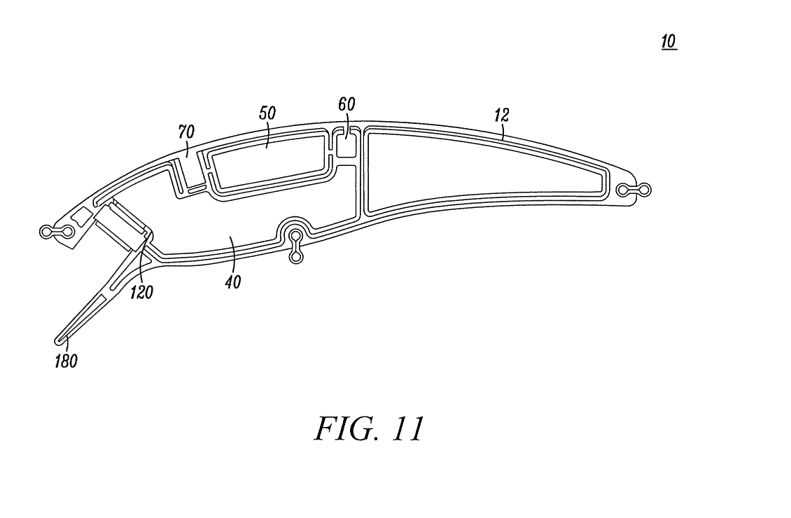

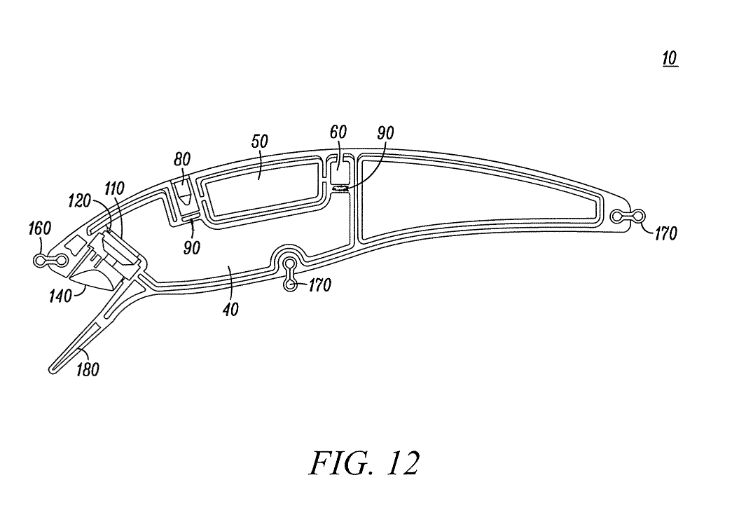

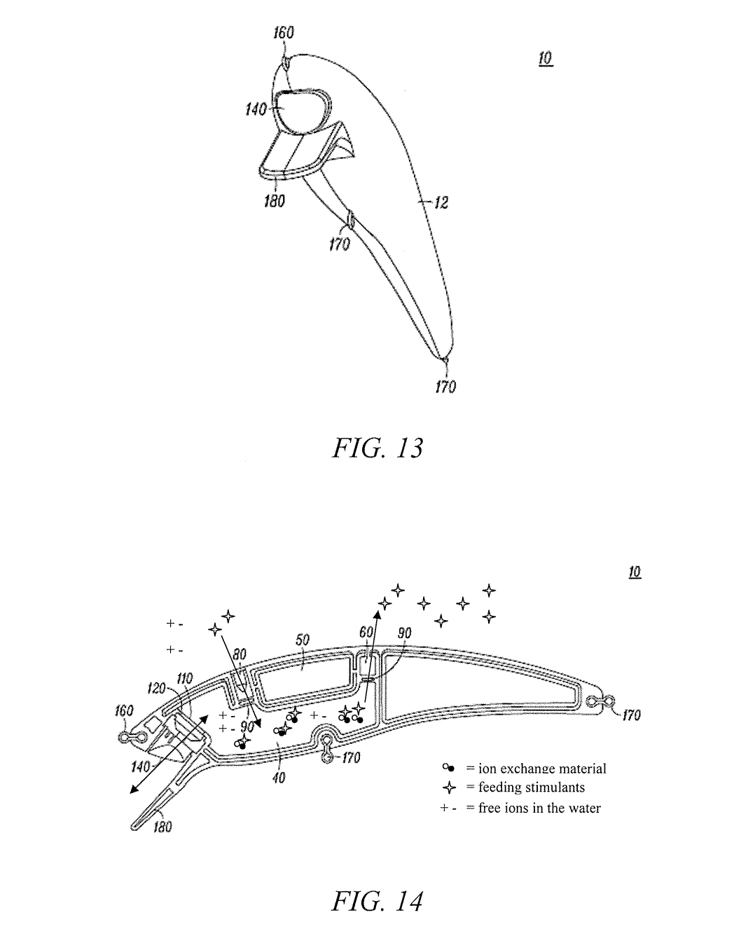

In one aspect the present invention relates to a fishing lure assembly. For convenience and to avoid confusion, like numerals are used to represent comparable structures throughout all the figures and exemplary embodiments. Referring to FIG. 11-14, a fishing lure assembly 10 is shown. The fishing lure assembly 10 has a body 12. For orientation purposes only, reference may be made to the anterior portion 20 or posterior portion 30 of the body 12. In the shown embodiment, the body 12 has a fish shape, however, many other body shapes, and sizes can be used. The body 12 of the fishing lure assembly 10 can be made from metal, plastic, wood, foam, rubber, polymeric or other elastomeric material. However, it is preferred that at least a portion of the body 12 be impermeable to water.

In certain embodiments, the lure body 12 of the fishing lure assembly 10 defines an internal fill chamber 40. In the shown embodiment, the body 12 of the fishing lure assembly 10 is divided into two sections that are molded, heat sealed, welded, glued, screwed or fastened together using any technique known to those in the art of plastic molding. The lure body 12 defines at least one internal chamber. In the embodiment shown, the body 12 defines an internal fill chamber 40 and an internal air chamber 50. The internal fill chamber 40 is capable of retaining and storing a volume of a fill composition, while the internal air chamber 50 is hermetically sealed and may comprise a volume of gas or air to modify the buoyancy of the lure. Also, in the embodiment shown, the body 12 comprises at least one passageway or hole (60, 70, and 210) through the body 12 which is in communication with the internal fill chamber 40.

A first passageway or hole 60 through the body is in fluid communication with the internal fill chamber 40 and defines a flow path therebetween. In the exemplary embodiment shown in FIG. 11-14, the body 12 comprises a second passageway or hole 210 through the body that is in communication with the internal fill chamber, and wherein the second passageway 210 includes a biasing member 100 disposed therein. The biasing member 100 comprises a spring or diaphragm 110 and an actuator 140. The spring or diaphragm having a predetermined modulus of elasticity, and including a hermetic seal over the opening of the second passageway 210, and wherein the biasing member 100 communicates with the internal fill chamber. In certain embodiments, the lure of the invention also comprises at least one other passageway or hole 70 through the body that is in fluid communication with the internal chamber, defining a flow path therebetween. In certain embodiments the passageway 70 serves as a “fill port” for the addition of a fill composition.

The diameter and number of passageways depend upon the size of the body 12 and the internal chamber 40. The passageway 60 allows water to flow into and out of the internal chamber 40 once the lure assembly 10 is submersed in water. The passageway 60 also allows air to escape from the internal chamber 40 so that the lure assembly 10 will not remain overly buoyant when placed into water. In one embodiment the passageway 60 is of sufficient diameter to allow between one and fifty cubic millimeters of water to pass into, and out of, the body 12 of the lure assembly 10 per minute as the lure assembly 10 is drawn through the water. Larger lures can have larger flow rates. Smaller lures can have smaller flow rates.

In any of the embodiments described herein the biasing member 100 comprises a spring body or diaphragm 110 including: a body base and contacts, and forms a hermetic seal with a spring seat 120, wherein the spring seat 120 defines a diameter less than the base of the spring body 110, and a stem which extends between the spring body 110 and an actuator 140, wherein the actuator 140 is capable of being axially displaced in response to a predetermined amount of external pressure, for example, by hydrostatic pressure caused by drag as the lure is pulled through the water.

With reference to the schematic diagram in FIG. 14, as the actuator 140 is displaced inwards towards the body 12, the relative pressure within the internal storage chamber 40 is increased due to convection (i.e., because the spring body 110 is in direct communication with the fluid in the internal fill chamber 40, the internal hydrostatic pressure is increased as the spring or bellow 110 moves inward it pushes on the fluid in the chamber resulting in turbulence), effectuating release of fluid containing scent and/or attractant through the first passageway 60. Once the pressure in the internal storage chamber 40 reaches a maximum, the biasing member 100 (and spring body 110) recoils, displacing the actuator 140 in the opposite direction, and lowering the pressure in the internal storage chamber 40. As the relative pressure in the internal storage chamber 40 decreases water enters through the first passageway 60, until the pressure gradient diminishes to an equilibrium point inside the internal storage chamber 40. As the lure 10 passes through the water the biasing member 100 oscillates or pulses continuously as described, resulting in a slow and controlled release of scent and/or attractant from the lure 10.

From FIG. 14, it can be seen that the ionized scent compounds are mixed with the ion exchange material. Due to the opposite charges between the ion exchange material and the scent compounds, the scent compounds electrostatically bond to the surface of the ion exchange material. This creates the lure fill composition. The lure fill composition is placed within the body of the lure assembly 10. Once the lure fill composition is exposed to water, ions in the water bond to the ion exchange material and replace the scent compounds. This frees the scent compounds into the surrounding water. The scent compounds then flow out of the lure assembly 10 with the passage of water. Obviously, the rate at which the scent compounds are released into the surrounding water rely upon many variables. These variables include the volume of scent compounds present, the surface area of the ion exchange material, the strength of the electrostatic bonds, the amount of free ions in the water and the rate of water exposure. To limit the ion exchange between the passing water and the lure fill composition, a molecular sieve 90 is provided. The lure fill composition is enclosed behind a molecular sieve 90. Once the scent compounds are released, those scent compounds must also pass through the molecular sieve 90 before they can flow out of the lure assembly 10. Thus, by providing the molecular sieve 90, flow into and out of the lure fill composition can be controlled.

There exist molecular sieves 50 of various pore sizes or molecular weight cutoffs. For example, polymeric dialysis or semipermeable membranes could be utilized and placed over the sieve body 90. Dialysis membranes suitable for use in the present invention are well known and readily available. A molecular sieve 90 can therefore be provided that presents the proper flow characteristics for the size of the lure assembly 40 and the lure fill composition 20 being used.

In any of the preferred embodiments, the spring body 110 can be a spring, a bellow, a dome-shaped spring, diaphragm or the like constructed from any suitable material known to those of skill in the art, for example, a metal, a foam, rubber or polymeric or elastomeric material. In certain other aspects, the actuator 140 is substantially rigid in order to protect the spring body or diaphragm 110 from damage, for example, tearing or puncture due to excessive external pressure, such as from the force of water, fish teeth, or fish biting or chewing.

In certain embodiments, the biasing member 100 is contained in a housing formed as part of the body of the lure. However, in certain embodiments, the biasing member 100 protrudes out and is raised relative to the surface of the body 12. In addition, as those of skill in the art will recognize, the biasing member 100 can be located on any part of the lure (e.g., anterior portion, posterior portion, laterally, dorsally or ventrally). As such, the examples of the preferred embodiments are not to be construed as limiting on the scope of the present invention. However, in one embodiment of the lure, the biasing member 100 is located at the anterior portion of the lure and is flat or recessed with respect to the surrounding lure body.

In certain embodiments the lure of the invention also comprises a fill-port 70, which includes a one-way fill valve 80 comprising a valve body including a valve base, defining another passageway through the body of the lure that is in fluid communication with the internal chamber and defines a flow path therebetween, a valve seat, and a valve cover defining a predetermined modulus of elasticity, wherein the modulus of elasticity is selected to (1) define a predetermined valve opening pressure generated by a pressurized liquid that allows passage of the material through the valve opening and into the storage chamber, and (2) prevent the ingress of unpressurized material into the storage chamber and egress of materials out of the storage chamber.

A fill composition is used to fill the internal chamber 40 of the fishing lure body 12 through fill port 70. This fill composition releases fish scent compounds into the water that flows from the internal chamber 40 of the fishing lure body 12 through the passageway 60. As such, the fish scent compounds are released into the water surrounding and trailing the fishing lure assembly 10. One advantage of the present lure assembly is that once the scent and/or attractant component of the fill composition is exhausted, they can easily be replaced or “recharged” with additional attractant material. The fishing lure assembly 10 is then quickly ready for reuse. In certain embodiments, the invention includes a method for quickly flushing the ion exchange component of the fill composition with an aqueous buffer or an organic buffer. In certain aspects the rinse buffer has an ionic concentration, pH, or other chemical feature that induces the release any unbound attractant and flushes the waste out the exit port 60. In this manner, the specific attractant composition can be quickly and easily changed to suit the changing fishing conditions or species sought.

In certain aspects, the fill composition used to fill the internal chamber 40 of the fishing lure body 12 may additionally comprise an ion exchange material. The ion exchange material can be any material that is capable of maintaining a positive or negative surface charge. In this aspect the fish scent compounds are ionized and are electrostatically bonded to the ion exchange material. The scent material bonded to the ion exchange material creates the fill composition. The fill composition is then placed within the internal chamber 40 of the fishing lure body 12. When the fishing lure body 12 is submersed, water seeps into the internal chamber 40 through the passageway 60. As water contacts the fill composition, the salt and/or mineral ions contained in the water replace the ionized fishing scent compounds and bond to the ion exchange material. As a result, the scent compounds are released into the surrounding water and escape from the fishing lure assembly 10.

In certain aspects the invention includes methods for creating the fill composition comprising providing a volume of ion exchange material. The ion exchange material is preferably granular in composition, so as to maximize exposed surface area available within the ion exchange material. The ion exchange material is then ionized with a positive charge to produce an anion exchange material, or a negative charge to produce a cation exchange material. The fish scent compounds are then provided. The fish scent compound is ionized with a charge opposite that of the ion exchange material.

In certain aspects, the passageways (60 and 70) through the body 12 are partially obstructed, for example, by a dialysis membrane or molecular sieve 90 in order to prevent the egress of material greater than a predetermined size. As used herein, the term “sieve” is used generally and refers to sieves, filters, screens, fibrous or paper cloths, porous membranes, and the like. In certain embodiments the sieve 90 comprises a body including a filter membrane contained on or within a rigid frame or housing, such as a plastic support. In certain embodiments the sieve 90 will have a pore size sufficiently small to retain the selected ion exchange material while allowing for the passage of small molecules, for example, ions, amino acids, salts, buffer, water, detergents, and the like. In certain aspects the sieve 90 pore size ranges from about 0.1 μm to about 1 mm. In a preferred embodiment, the sieve 90 comprises a membrane having a pore size of from about 0.1 μm to about 5 μm. Materials that could be utilized in constructing the sieve 90 in any of the preferred embodiments includes those currently known or yet to be developed, including for example, organic polymers, polyvinylidene fluoride, polytetrafluoroethylene, polycarbonates or polyesters, cellulose acetate, nitrocellulose, silica, ceramics, metals, papers, cloths or fibers, and the like. Methods of manufacturing such sieves is widely known and includes the use of photolithographic techniques and nanotechnology to generate filter membranes with specific pore size and configuration architectures that can further modify and control the release of the scents and/or attractants. It will be understood by those of ordinary skill that the particular sieve characteristics may be varied depending on the desired release characteristics in accordance with the present description without undue experimentation, and the examples described herein are not to be construed as limiting on the scope of the current invention.

In any of the preferred embodiments, the configuration and number of internal chambers, fluid passageways, and biasing members can be varied in any number of ways which would be understood by someone of ordinary skill in accordance with the present description, and such combinations are expressly contemplated as being within the scope of the present invention. The embodiments provided herein are given by way of example, and are not to be construed as limiting. For example, the inventors contemplate a lure containing multiple internal fill chambers, each with its own one-way fill valve, exit port, micro sieves or filters, and biasing member. In another embodiment, the lure body 12 comprises a rigid or elastomeric body segment that comprises a plurality of pores or channels such that the scent compounds are released upon physical deformation, for example, from the force of a fish biting the elastomeric body segment.

In another aspect the invention relates to methods for releasing scent and/or attractants comprising moving the lure of the invention through the water in a horizontal direction, vertical direction, lateral direction or combinations thereof. As would be understood by those of ordinary skill in the art, the lure can be modified in any number of ways in order to manipulate its movement in water, and the examples provided herein are not to be construed as limiting on the scope of the invention. For example, a lure constructed according to the invention can be modified such that scent and/or attractant is released due to lateral movement, e.g., “wiggling”, in addition to or instead of due to horizontal or vertical movement.

In any of the embodiments the lures of the present invention may be of any type known generally to those of skill in the art, including, for example, spoons, plugs, crawlers, chuggers, jerkbaits, spinners, buzzbaits, flies, crank baits, jigs, poppers, trolling lures, rigid lures, soft or flexible lures or combinations thereof.

In addition, the lures of the present invention can be of any desired size, shape, or color, which can be varied depending on the particular fish species sought and/or fishing conditions. Furthermore, all or portions of the lures of the present invention can be constructed out of a hard or rigid-type material, for example, hard plastic, metal, or wood; or a soft or flexible material, for example, foam, elastomeric polymer, and the like. As such, the current embodiments are given by way of example only.

In any of the embodiments described herein, the fill composition contains a first volume of at least one ion exchange material and at least one second volume of scent and/or attractant material. The ion exchange material binds and retains the scent and/or attractant material via ionic bonds. Disruption of the ionic binding, for example, by changes in the pH, ionic strength, temperature, ion concentration, addition of detergent, or the like results in release of the scent and/or attractant material.

There are many types of ion exchange materials that can be used. Such materials include, but are not limited to, sulfinated coal, polyamides, silica, powdered fire brick, alumina and montmorillonite clay. However, in the preferred embodiment of the present invention, an ion exchange resin is used as the ion exchange material. Ion exchange resins are typically manufactured as small spheres or beads. The exchange materials contemplated can be of any suitable type known to those of skill in the art including, for example, organic polymers, sepharose, dextran, styrene, polystyrene, ethylene, divinylbenzene, and the like. The ion exchange resins contain active groups capable of undergoing ionic binging with specific chemical functionalities, for example, through ionic binding, hydrophobic or polar interactions, hydrogen bonding, etc., for example, sulfonic acid is used for cation binding, and amines and trimethylbenzylammonium for anion binding, There are several types of ion exchange resins currently being commercially produced. Some of these ion exchange resins are manufactured by Dow Chemical and sold under the name Dowex Monospheres™, Spectrum of Houston, Tex. and are sold under the name Spectr/Gel®; others include those manufactured by Rohm & Haas, Inc. of Blue Bell, Pa. and are sold under the brand names Amberchrom™, Amberjet™, Amberlite™, Amberlyst™, Duolite™, and IMAC™. The medium (75-150 μm diameter) and large (150-300 μm diameter) beads are most useful for gravity flow and batch (non-flow) applications. The larger size of the beads makes for ready flow and easy separation from a bulk liquid. The medium (75-150 μm diameter) and small (10-75 μm diameter) beads are most useful for pumped applications. The smaller size of the beads provides more rapid equilibration at higher flow rates. The charged analytes are attached to the exchange groups in the column, they must be eluted out using a buffer with a higher ionic strength or a different pH in order to weaken the electrostatic interactions between the analytes and the exchangers.

This technique separates proteins according to their net charge. For example, if a protein has a net positive charge at pH 7, then it will bind to a column of beads containing carboxylate groups (negative charge) whereas a negatively charged protein would not. By adjusting the pH or the ionic concentration, various protein molecules can be separated.

As such, it is expressly contemplated by the present invention that the particular combination of ion exchange material and scent and/or attractant materials may be varied in any number of ways to result in release of an effective amount of scent and/or attractant in any desired water conditions through the use of the teachings of the present invention without undue experimentation. Accordingly, the examples provided herein are not to be construed as limiting on the scope of the invention.

In certain embodiments, the fill composition comprises multiple types of ion exchange material such that the lure is capable of releasing more than a single type of scent and/or attractant material, and/or is capable of releasing material at variable rates.

In other aspects, the lures of the invention comprise a secondary physical feature that stimulates a fish to bite the lure. Other physical features contemplated by the invention include variable light diffraction coatings resulting in a more lifelike or natural coloration of the bait; a low frequency sound producing device to mimic the sound of natural bait prey swimming through the water; lure body designs that result in movement, for example, lateral, vertical or both, which mimics the movement of natural bait prey.

To further enhance the effectiveness of the lures of the invention, certain embodiments also comprise color patterns and reflective properties that attract fish, and/or produce sound for attracting fish.

Visual systems that can be utilized in any of the embodiments of the invention include, for example, prisms and prismatic or holographic coatings—these include films, acrylic and meth-acrylic plastics or similar plastic polymer which has been manufactured in order to create a prismatic effect when struck by light. The characteristics may include micro-prismatic structures that may molded in such a way as to give an external prismatic structure that is evident by its texture, or as a result of a systematic and/or methodical fracturing of a clear and or reflective polymer in order to create a vehicle for the internal refraction of ambient light creating a desired prism. In other embodiments, the lure body is covered using “radiant light film,” whereby different colors of the visible light spectra are reflected giving the appearance of changing color when viewed from changing angles. Currently, radiant light films are commercially available from manufacturers such as 3M®.

Other materials and methods useful for producing lures that are visually pleasing to predacious fish include materials and/or films that are specifically designed and manufactured to reflect or refract tri-chromatic colors which are short in wave length as a means to attract fish. Examples include those colors of the U.V and visible light spectrum such as blue and green, and would when contacted by ambient light under water, electro chromic materials which can emit certain frequencies of light which may be desirable to fish. Electrochromic groups include: tungsten, molybdenum (an ion exchange material), titanium, manganese, vanadium, ruthenium, iridium, rhodium, and niobium. Other materials, such as, photonic fibers which emit a certain wave length that may be detectable by fish for means of attraction. These act as “dielectric mirrors” but possess the strength and durability of “man made fibers.” These can reflect light in certain ranges of wave lengths but can also absorb light outside a particular range. Photonic fibers can be manufactured from Arsenic Triselenide or Poly-ether Sulphone. Still other examples include, materials that reflect or refract ultra violet frequencies—which are less than 400 nanometers when contacted by ambient light under water; materials that reflect ambient light under water and give off polarized light. These are materials which transform ambient light in water and give off a polarizing light; bacteria and/or proteins that exhibit a naturally occurring bioluminescent or luminescent quality when immersed in water.

The invention also contemplates the use of chemi- and electroluminescent materials within a fishing lure device or trap with the intention of attracting fish. With these materials, valance electrons are excited to high energy levels; emitting light as photons as they decay to a resting state. Electroluminescent materials give off light when electric current is applied and give off no heat (very efficient). These materials include: GaAs, CDS, InP, and GaN. These materials come from periodic groups 2,3,5,6. Conjugated examples include Poly Alkyl-Fluorenes, Polyparaphenylene, and poly (p-pyrdine). Polythiophenes and PPV's can exhibit electroluminescence from blue to near infra-red depending on substituant groups.

In another aspect, the invention includes a method of transposing the optical image of fish or other desired marine and/or terrestrial animal onto the surface of a polymer. Said image may be transferred onto a variety of films which would be suitable for thermo-forming or vacuum-forming onto other materials such as found in the diverse variety of polymers. Where said optical image of a marine and/or terrestrial animal is transferred to a polymer by means of a high pixel resolution printing and or copying apparatus such as those devices developed and marketed by the European corporation, OCE, Inc.

The lures of the present invention are designed to work in every level of the water column and are easy to “charge” with feeding stimulants. From top water bass plugs to diving crank baits (having a projecting lip forcing the lure to swim in a downward trajectory), to off-shore marlin and tuna lures, every type of fisherman, and every style of fishing.

In additional aspects the current invention relates to compositions comprising fish scent and/or attractants reversibly bound to polymeric foams or gels. In certain embodiments the polymeric foams or gels are composed of environmentally friendly, non-toxic substances that can be harmlessly consumed by aquatic life, and/or breakdown readily due to ingestion, exposure to light, temperature, ionic strength, or the like. Examples of materials that can be used to create foam baits with scent and/or attractant materials incorporated therein, either by forming chemical bonds or being physically entrapped in a polymeric matrix are known to those in the art. Foam baits according to the methods of the invention provide an advantage over the currently used products, such as natural chums, because they allow for better visibility on the water surface and controlled release of scent and/or attractant. In certain aspects, the foam bait of the invention comprises a hydroxymethyl cellulose matrix containing chemical scent and/or attractant disposed therein. As the HMC matrix dissolves in water the fish attractants are released. In related aspects, the invention relates to a bait formulation comprising the foam bait composition of the invention in combination with natural chum.

Polymeric foam or gel baits and chums of the invention contemplate the use of dry pharmaceutical grade amino acids or food grade amino acids, peptides, and/or proteins, for example, Betaine, Tryptophan, Proline, Methionine, Leucine, arginine HCL, Alanine Leucine, Glycine, L-Phenylalanine, hemoglobin, and/or ground animal tissues, for use with ion exchange materials and or polymeric foams. Such foams or chums can be sprayed directly into the water in order to attract marine life such a fish. Such compositions may also be useful as a feeding stimulant (coat fish food) for use in fish farms as a means to encourage fish to ingest medications such as antibiotics.

The encapsulation of ionic and/or organic and/or metallic containing molecules from a slow dissolving foam type polymer which may be engineered so that it is biodegradable or photo-degradable with the intended purpose to release attractant chemicals into the environment as the polymer degrades. Materials such as polyvinal alcohol or derivatives of cellulose family or locust bean gums may be mixed with amino acids or ground tissues from fish or powered hemoglobin, and placed into an accelerant containing canister. Upon release, a pressurized foam would emerge that would contain said amino acids along with above mentioned molecules and compounds. This includes a polymeric chemical and/or compound containing attractant chemicals such as amino acids, carbohydrates or proteins that could be presented as a degradable foam that upon dissolution of the polymer matrix release said amino acids, carbohydrates and/or proteins into the external environment. These polymeric materials may consist of a variety of cellulose byproducts or derivatives, such as methyl cellulose or hydroxy methyl propyl cellulose and/or locust bean gum and/or polyvinyl alcohol and/or agar (in its various forms). Includes applications for Polymeric Foams, Polymeric Chums. In any of the embodiments of this aspect of the invention, wet Electroactive Polymers (EAP's) or Ionic Electroactive Polymers can be utilized which exhibit dimensional change brought about by an external stimulus with the intent of releasing chemicals into the environment for the purpose of attracting fish. These are polymers that are immersed in an electrolytic fluid that, when an external stimulus (such as an electric field) can exhibit a significant change in dimension or geometry.

Additional polymer gels that can be used in this aspect of the invention include polymer gels that take on water and expand or conversely, expel water and contract in response to change in electrical field or chemical environment; and/or polymer gels that release attractant due to a change in PH, electric field, temperatures, light or external environmental conditions. Examples include: Polyacroylonitrile (PAN) used in gel systems and may also be referred to as a Polyelectrolyte; Polyvinyl alcohol-Polyacrylic acid which is activated specifically by variations in pH; ionic polymer metal composites where carbon atoms bond to fluorine; Flemion (a perfluorocarboxylate) or Nafion (perflurosulfonate) which will swell in water due to an ionic and hydrophilic nature—these can exhibit dimensional change in an electric field; conductive polymers which exhibit electrochemical oxidation or reduction processes, conventionally referred to as doping—these materials may be used to aid in the migration of attractant chemicals into or from a fishing lure device (These materials undergo a volume change when they undergo an electrochemical oxidation or reduction process called “doping”), and include: Polyacetlene, Polyaniline, Polypyrrole, Polythrophene.

Examples of alternative embodiments of the Invention. The following options may additionally be incorporated into the fishing lure assembly as described and claimed herein.

### EXAMPLE 1

An electro-mechanical pump may be used to release attractant molecules from a fishing lure or other device at a periodic rate which may be controlled by a micro processing device powered by small batteries, for example rechargeable batteries such as those recharged by solar power.

### EXAMPLE 2

An attractant containing suppository which may be placed within a fishing lure device and either manually or electronically compressed as to be expelled from a holding chamber into an external environment.

### EXAMPLE 3

The use of nano-structures as a means of delivery system for molecules, and specifically ionic molecules from a device submersed in water. This nano-structure (nano-pore) may contain a material such as a gel (hydro-gel) which would contain amino acids, that when contacted by an aqueous solution releases it's ionic molecule contents into the external environment. The nano structure may contain a gate that may be encouraged to open and close based on stimuli.

### EXAMPLE 4

The use of polyelectrolyte multi-layers as a means to release ionic molecules such as amino acids or nonionic molecules such as hemoglobin for the expressed use of releasing attractant chemicals into the external environment. Polyelectrolyte multi layers (PEMS) are polymer thin films that may be placed on surfaces one molecular layer at a time. This method could be used for the slow release of feeding stimulant molecules.

### EXAMPLE 5

The use of Electrostriction and/or magnetostrictors which exhibit a dimensional or tortional change when a mild electrical current and/or magnetic field is introduced would also be included as a functional diaphragm for the lure of the invention. Electrostriction and/or magnetostrictors as a means to create an artificial fishing lure device which upon the introduction of slight electrical or chemical stimulus would exhibit a dimensional change and corresponding movement resembling a living creature. Examples of this would include Terfenol-D.

### EXAMPLE 7

A mechanism for the automatic re-charging of electrically powered devises whose electrical current is derived from batteries. An solar strip may be embedded in such a way as to come into direct light especially when used outdoors. This would prove beneficial for use in a fishing lure which need a supply of electric current.

### EXAMPLE 8

An electronic noise producing fishing lure that would produce sound at or below 250 Hz.

### EXAMPLE 9

The use of a tear-drop shaped devise whereby the slender shaft is inserted into a hollow tube and places in water. The slender shaft may be tethered in some fashion to the tube. The tube would release a material (feeding stimulant or foam) that would travel the three hundred sixty degrees around the shaft. The material would then broaden as it would contact the widening slope of the tear-drop. The material would then be forced out in a wide and diffuse pattern away from the tube and tear drop extension. The slender tear-drop shaft could be drawn into the tube for an extremely broad dispersal of material or may be allowed to be moved farther back from the tube for a less dramatic dispersal pattern.

It will be understood that the embodiments of the present invention that are illustrated and described are merely exemplary and that a person skilled in the art can make many variations to the shown designs. For example, the shape of the lure assembly can be modified into any lure shape, size or color known or which becomes known. Furthermore, there are countless ways to position the fill composition within or around a lure body so that the fill composition is exposed to a controlled volume of passing water. All such variations, modifications and alternate embodiments are intended to be included within the scope of the present invention as defined by the claims.

1. A fishing lure assembly comprising:
a body member defining therein at least one internal storage chamber for receiving and storing a volume of a fill composition;
a first passageway formed therethrough that is coupled in fluid communication with the internal storage chamber of the body and defines a flow path therebetween for the ingress and egress of fluid; and
a second passageway formed through the body member that is in communication with the internal storage chamber of the body, and includes a biasing member disposed therein having a predetermined modulus of elasticity.

2. The fishing lure of claim 1, wherein the biasing member comprises a spring body, and an actuator.

3. The fishing lure of claim 2, wherein the spring body comprises a spring stem, spring base, and a spring seat, wherein a hermetic seal is formed between the spring base and the spring seat, and wherein the spring stem extends to and attaches to the actuator.

4. The fishing lure of claim 3, wherein the actuator is capable of being axially displaced in response to a predetermined amount of hydrostatic pressure.

5. The fishing lure of claim 1, wherein the body comprises a third passageway formed therethrough that is coupled in fluid communication with the internal storage chamber of the body and defines a flow path therebetween, and including a one-way valve comprising a valve seat, a valve stem, and a valve cover defining a predetermined modulus of elasticity, wherein the modulus of elasticity is selected to (i) define a predetermined valve opening pressure generated by a pressurized liquid that allows passage of the material through the valve opening and into the storage chamber, and (ii) prevents the ingress of unpressurized material into the storage chamber and egress of materials out of the storage chamber.

6. The fishing lure of claim 1, wherein the fill composition comprises a ion exchange material.

7. The fishing lure of claim 6, wherein the fill composition further comprises a scent material.

8. The fishing lure of claim 7, wherein the ion exchange material is an anion exchange resin, a cation exchange resin or a combination thereof.

9. The fishing lure of claim 1, wherein the body member further comprises a second internal storage chamber, wherein the second internal storage chamber is hermetically sealed and contains a volume of gas or air disposed therein.

10. The fishing lure of claim 1, wherein the body is composed of a material selected from the group consisting of plastic, metal, wood, foam, rubber, elastomeric material, and combinations thereof.

11. The fishing lure of claim 1, further comprising an additional fish attracting feature selected from the group consisting of visual, auditory, olfactory, tactile, gustatory, vibrational, and combinations thereof.

12. The fishing lure of claim 6, wherein the scent material comprises an organic compound, an amino acid, a peptide, a polypeptide, a protein, an oil, a lipid, an amide or a combination thereof.

13. The fishing lure of claim 6, wherein the scent material comprises a natural animal tissue component and a synthetic component.

14. The fishing lure of claim 13, wherein the synthetic component comprises an isolated amino acid.

15. The fishing lure of claim 6, further comprising a sieve, wherein the sieve contains a plurality of pores therein having an opening less than that of an ion exchange material.

16. A method for releasing scent material into the water comprising:
providing a fishing lure of claim 1, further comprising a scent material bound to an ion exchange material retained in the internal storage chamber; and
moving the fishing lure through water, wherein the external hydrostatic pressure axially displaces the biasing member causing the pressure within the internal storage chamber to increase and forcing a volume of liquid containing a scent material through the first passageway and to the outside of the lure body member, wherein the biasing member recoils causing the pressure in the internal storage chamber to decrease and thereby drawing a volume of liquid into the internal storage chamber.

17. The method of claim 16, wherein the scent material comprises an organic compound, an amino acid, a peptide, a polypeptide, a protein, an oil, a lipid, an amide or a combination thereof.

18. The method of claim 17, wherein the scent material comprises a natural animal tissue component and a synthetic component.

19. The method of claim 18, wherein the synthetic component comprises an isolated amino acid.

20. A fishing bait foam or gel comprising a polymeric material and a scent material.
